(19) United States
(12) Patent Application Publication
(10) Pub. No.: US 2010/0138419 A1
(43) Pub. Date: Jun. 3, 2010

(54) Method of Providing Moving Picture Search Service and Apparatus Thereof

(75) Inventors: Kil-Youn Kim, Seoul (KR); Sun-Ok Cho, Seoul (KR); Dae-Bong Park, Seoul (KR); Jae-Hyung Lee, Yongin-si, Gyeonggi-do (KR)

Correspondence Address: INTELLECTUAL PROPERTY LAW GROUP LLP, 12 SOUTH FIRST STREET, SUITE 1205, SAN JOSE, CA, 95113, US

(73) Assignee: ENSWERS CO., LTD., Seoul (KR)

(21) Appl. No.: 12/598,200

(22) PCT Filed: Jul. 18, 2008
(86) PCT No.: PCT/KR08/04222

§ 371 Date: Oct. 29, 2009

(30) Foreign Application Priority Data
Jul. 18, 2007 (KR) 10-2007-0071633

(51) Int. Cl. G06F 17/30; G06F 3/00

(52) U.S. Cl. 707/737; 715/762; 707/E17.074

(57) ABSTRACT

A method of providing a moving picture search service and an apparatus therefor are disclosed. An embodiment of the present invention provides a method of providing a moving picture search service that includes: obtaining a search keyword from a client terminal; and providing as search results a moving picture cluster list displaying information about a moving picture cluster matching with the search keyword. The moving picture cluster includes a plurality of moving pictures determined to have identity, and the moving picture cluster list includes a cluster unit display area displaying information about the moving picture cluster differently from information about another moving picture cluster included in the moving picture cluster list. By providing moving picture search results related to a search keyword in groups of cluster units, users can understand the search results more easily.

### TECHNICAL FIELD

The present invention relates to a method of providing a moving picture search service and an apparatus thereof.

### BACKGROUND ART

With the development of internet technologies and popularity of video photographing equipment, including digital cameras, “UCC (user created contents)” is no longer an unfamiliar jargon. Unending drop in cost of storage and continuous expansion of broadband communication networks allow more people to share information in forms of moving pictures, not in forms of still images. Introduction of services such as You Tube (http://www.youtube.com) provides an environment in which moving pictures are shared more easily.

Despite the astronomical multiplication of the number of moving pictures that are shared on the Internet, the development of technologies for searching moving pictures has been rather slow. The results of moving picture search are usually provided by listing the moving pictures that are related to the key word(s) inputted by a user, for example, moving pictures that include such key word(s) in the title.

In such a case, earlier lists of the search results often show the same moving pictures redundantly. When most of the search result screen is covered by the same moving pictures, users often have to click through next pages inevitably until a different moving picture is finally found.

What is required, therefore, to overcome this problem is a method of providing search results more efficiently on a finite screen that displays the search results.

### DISCLOSURE

### Technical Problem

An aspect of the present invention provides a method of searching moving pictures, and an apparatus thereof, for improving the efficiency of providing moving picture search results, by using moving picture clusters that include moving pictures having identity.

### Technical Solution

An aspect of the present invention features a method of providing a moving picture search service, which includes: obtaining a search keyword from a client terminal; and providing as search results a moving picture cluster list displaying information about a moving picture cluster matching with the search keyword. The moving picture cluster includes a plurality of moving pictures determined to have identity, and the moving picture cluster list includes a cluster unit display area displaying information about the moving picture cluster differently from information about another moving picture cluster included in the moving picture cluster list.

The moving picture cluster list can include a plurality of cluster unit display areas, and the plurality of cluster unit display areas can be arranged based on the number of moving pictures included in each moving picture cluster corresponding to each of the cluster unit display areas.

The moving picture cluster list can include a plurality of cluster unit display areas, and the plurality of cluster unit display areas can be arranged based on cluster representative times for their corresponding moving picture clusters, and the cluster representative times can be generated based on a generation time of a moving picture included in each cluster.

The cluster representative time can be an earliest time among generation times of moving pictures included in each moving picture cluster.

The cluster unit display area can display a link referencing location information of a moving picture belonging to a moving picture cluster corresponding to the cluster unit display area.

The cluster unit display area can display links for a plurality of moving pictures belonging to the moving picture cluster, and the links can display corresponding moving pictures based on a temporal arrangement order in the moving pictures cluster.

The temporal arrangement order can consider at least one of a relative start time and a relative end time in a cluster that each of the plurality of moving pictures has.

The link can use a still image of the moving picture as a display image of the link. The cluster unit display area can display links for a plurality of moving pictures belonging to the moving picture cluster, and the plurality of links can be arranged based on an order of arrangement of still images corresponding to display images of the links in an entire playback time section of the moving picture cluster.

Additional information can be provided for the moving picture related to the link, in case a pointer of a graphic user interface (GUI) realized on the client terminal provided with the moving picture cluster list is placed on the link.

The cluster unit display area can display at least one of start time information and end time information of a section occupied in an entire playback time section of the moving picture cluster corresponding to the cluster unit display area.

The cluster unit display area can display information about a representative moving picture selected among moving pictures belonging to the moving picture cluster matching with the search keyword.

The information about the representative moving picture displayed in the cluster unit display area can include at least one of links referencing a still image of the representative moving picture and the representative moving picture.

The representative moving picture can be selected based on a length of a moving picture belonging to the moving picture cluster matching with the search keyword. The representative moving picture can be selected based on the number of other moving pictures having identity with a moving picture belonging to the moving picture cluster matching with the search keyword.

A program for executing a method of providing a moving picture search service in accordance with an embodiment can be recorded in a computer-readable recording medium.

Another aspect of the present invention features an apparatus for a moving picture search service, which includes: a database, storing information on a moving picture cluster including a plurality of moving pictures determined to have identity; and a moving picture searching unit, providing a moving picture cluster list displaying information about a moving picture cluster matching with a search keyword as search results, by searching the database, in response to the search keyword obtained from a client terminal. The moving picture cluster list can include a cluster unit display area displaying information about the moving picture cluster for each cluster.

The apparatus can also include: a moving picture comparing unit, detecting identity between two moving pictures by comparing the two moving pictures; and a cluster generating unit, forming a moving picture cluster by assigning a same cluster identifier to two moving pictures in which identity is detected by the moving picture comparing unit.

Other aspects, features and advantages of the present invention will become more apparent from the below drawings, claims and detailed description.

### DESCRIPTION OF DRAWINGS

FIG. 1 illustrates a connection between an apparatus for providing a moving picture search service and a user terminal in accordance with an embodiment of the present invention.

FIG. 2 shows a block diagram of an apparatus for providing a moving picture search service in accordance with an embodiment of the present invention.

FIG. 3 is a flowchart showing a method of providing a moving picture search service in accordance with an embodiment of the present invention.

FIG. 4 illustrates the structure of moving picture clusters that are used to realize a moving picture search service in accordance with an embodiment of the present invention.

FIG. 5 illustrates the structure of a moving picture list that is used to realize a moving picture search service in accordance with an embodiment of the present invention.

FIG. 6 illustrates results of a moving picture search that are displayed on a client terminal in accordance with an embodiment of the present invention.

FIG. 7 illustrates how moving pictures in a moving picture cluster are arranged on a common time axis in accordance with an embodiment of the present invention.

FIG. 8 illustrates results of a moving picture search that are displayed on a client terminal in accordance with an embodiment of the present invention.

### MODE FOR INVENTION

Hereinafter, certain embodiments of a method of providing a moving picture search service and an apparatus thereof will be illustrated and described with reference to the accompanying drawings. This, however, is by no means to restrict the present invention to certain embodiments, and shall be construed as including all permutations, equivalents and substitutes covered by the spirit and scope of the present invention. Throughout the description of the present invention, when describing a certain related technology is determined to evade the gist of the present invention, the pertinent detailed description will be omitted. Identical or corresponding elements will be given the same reference numerals, regardless of the figure number, and any redundant description of the identical or corresponding elements will not be repeated.

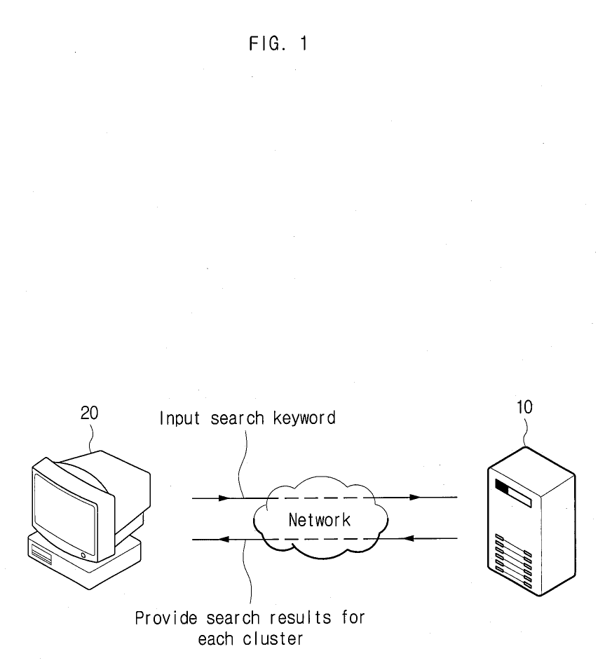

FIG. 1 illustrates a connection between an apparatus for providing a moving picture search service and a user terminal in accordance with an embodiment of the present invention.

Referring to FIG. 1, an apparatus for providing a moving picture search service 10 can be connected to a client terminal 20 through a network, such as the Internet. The apparatus for providing a moving picture search service 10 can receive a search keyword requested by the client terminal 20 and provide information on a moving picture cluster, which matches the received search keyword, as search results.

Moving picture cluster refers to a group of moving pictures that have identity. The moving picture cluster can be generated by assigning a same cluster identifier to moving pictures that have identity, i.e., moving pictures that share information that can be determined to be identical on the basis of predetermined criteria. The identity between two moving pictures can mean that the two moving pictures have identical segments.

However, two moving pictures that are included in one moving picture cluster do not necessarily have to share a common section, or have identity. In order for a moving pictures to be included in a moving picture cluster, it is required that the moving picture share a common section with at least one moving picture in the moving picture cluster. In other words, a first moving picture can be included in a moving picture cluster if the first moving picture has identity with a second moving picture in the moving picture cluster. In this case, the first moving picture does not have to necessarily have identity with a third moving picture in the moving picture cluster.

How the identity of moving pictures is determined and how the cluster is generated will be described later in detail with reference to another drawing.

The information on moving picture clusters that are related to the search keyword can be classified and displayed for each cluster, in the search results provided by the apparatus for providing a moving picture search service 10. In other words, an area of providing the information on one moving picture cluster can be separate from an area of providing the information on another moving picture cluster, and these areas can be arranged by use of criteria for each moving picture cluster within the search results. The criteria for arranging the information for each moving picture cluster within the search results will be described later in further detail.

The client terminal 20 is a terminal used by a user of a moving picture search service, which is provided by the apparatus for providing a moving picture search service 10. Devices such as a PDA, personal computer and mobile phone can be used as the client terminal. Furthermore, any device that can transmit a keyword to the apparatus for providing a moving picture search service 10 and display search results that are received as a result of such transmission can be used as the client terminal.

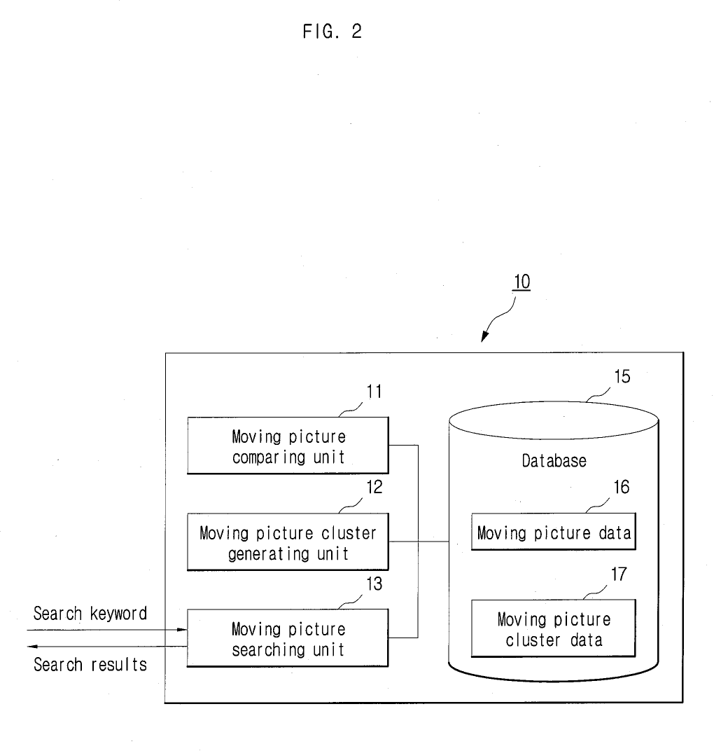

FIG. 2 is a block diagram of an apparatus for providing a moving picture search service in accordance with an embodiment of the present invention. Referring to FIG. 2, the apparatus for providing a moving picture search service can include a moving picture comparing unit 11, a moving picture cluster generating unit 12, a moving picture searching unit 13 and a database 15.

Each element of the apparatus for providing a moving picture search service can be realized by use of general computer hardware, and does not necessarily have to have a separate physical, hardware structure. General-purpose computer hardware can be referred to as one of the elements shown in FIG. 2 in accordance with its function.

The moving picture comparing unit 11 can compare moving pictures and determine whether there is identity between them. The moving pictures for comparison can be collected from the Internet prior to the comparison and stored in the database 15.

The object of the present invention is not restricted to mere determination of identity of moving pictures, and any related art that can determine identity between moving pictures can be used for the moving picture comparing unit 11. The moving picture comparing unit 11 can extract and compare fingerprint data of moving pictures as a criterion for determining the sharing of video information that is required for recognizing the identity of any two moving pictures.

The identity between two moving pictures is not restricted to the case of two moving pictures sharing perfectly identical binary data. If two moving pictures share video information that can be determined to be identical according to predetermined criteria, the identity between the two moving pictures can be recognized despite any difference in picture quality and/or playback time. In other words, the identity of video information and the identity between moving pictures, referred to in the present invention, shall be expansively understood as a meaning of substantial identity.

The moving picture comparing unit can obtain information on a common section (overlapping section) that is shared by two moving pictures. Time information on a common section, shared by another moving picture, in a moving picture, that is, time information on a start point and an end point of a common section within the moving picture, can be obtained. This information can be stored in the database 15.

The moving picture cluster generating unit 12 can perform a clustering operation for moving pictures that are recognized to have identity by the moving picture comparing unit 11. As described above, the moving picture cluster of the present invention can be understood as a group of moving pictures that have identity with one another. The moving picture cluster can be generated by assigning a cluster identifier to moving pictures that have identity.

The cluster identifier assigned by the moving picture cluster generating unit 12 and information on the moving picture, to which the cluster identifier is assigned, can be stored as moving picture cluster data 17 in the database 15.

The functions of the moving picture comparing unit 11 and moving picture cluster generating unit 12, mentioned above, can be understood by referring to PCT patent application PCT/KR2008/003142, filed on Jun. 4, 2008 under the title of “METHOD OF PROCESSING MOVING PICTURE AND APPARATUS THEREOF” and three Korean patent applications (10-2007-0054601, filed on Jun. 4, 2007, 10-2007-0060978, filed on Jun. 21, 2007, and 10-2008-0051688, filed on Jun. 2, 2008), of which priority was claimed for the PCT application. What was mentioned in the descriptions of the 4 above-identified patent applications can be considered to have been included as a part of the description of the present application.

The moving picture searching unit 13 can identify a moving picture cluster (or a moving picture) that matches the search keyword obtained from the client terminal 20, and provide information on the identified moving picture cluster (or moving picture) as search results.

The moving picture cluster matching with the search keyword can mean a moving picture cluster that includes a moving picture that matches with the search keyword. That is, in case a moving picture included in a moving picture cluster matches with the search keyword, the moving picture cluster can also match with the search keyword. Matching between a moving picture and a search keyword can be determined by comparing index information (supplementary information) of the moving picture and the search keyword. The index information of a moving picture can include the title of the moving picture, the copyright holder, the URL at which the moving picture is located, and text information that can be collected along with the moving picture at a webpage from which the moving picture is collected (for example, other text information included in the webpage to which the moving picture is inserted). This text information can be obtained by using software, such as Web Robot, which is used for an internet search engine in the related art.

In the moving picture search service in accordance with an embodiment of the present invention, the index information for each moving picture included in a moving picture cluster can be regarded as index information for the moving picture cluster. Thus, if there is a moving picture having index information matching with the search keyword, access to other moving pictures, which do not have the same index information but are included in the same moving picture cluster, can be provided to the user. This can result in a positive effect of expanding the search results.

The search results in accordance with an embodiment of the present invention can be provided as a moving picture cluster list that displays information on the moving picture cluster matching with the search keyword. A criterion to determine which moving picture cluster to be placed at a higher position in the moving picture cluster list is required.

The number of moving pictures included in a moving picture cluster can be considered in order to determine the priority of the moving picture clusters to be exposed in the search results. For example, the moving picture cluster that includes the most number of moving pictures can be given the highest position in the search results among the moving picture clusters matching with the search keyword.

Alternatively, information on the time of creation of moving pictures included in a moving picture cluster can be used in order to determine the priority of search results. The time of creation of a moving picture can mean the time at which the moving picture was actually photographed or the time at which the moving picture was uploaded to the cyberspace. Such information on the time of creation can be obtained from what is included in the moving picture itself or from a web document in which the moving picture is located.

In case a moving picture cluster includes a plurality of moving pictures, it is required to determine which moving picture to consider as the time of creation, in order to determine the priority of the moving picture cluster. For example, it may be preferable to regard, as the representative time (or the original time) of the moving picture cluster, the time of creation of the moving picture that has the earliest time of creation among the moving pictures included in the moving picture cluster. It is expected that a moving picture copied from another moving picture has a later time of creation than the original moving picture. Therefore, the earliest time of creation among the moving pictures included in a moving picture cluster can be regarded as the time at which the moving picture cluster was originated.

If a change of criteria for arranging the moving picture clusters is requested from the client terminal 20, the moving picture searching unit 13 can provide rearranged search results by reflecting such request.

The moving picture cluster information provided as search results in accordance with an embodiment of the present invention can include a link on a moving picture included in the moving picture cluster. The link for each moving picture can be provided in an area to which the information on each moving picture cluster is provided in the search results, that is, a cluster unit display area. In an embodiment of the present invention, the cluster unit display area displays information on one moving picture cluster, and in this context it can be referred to as a unit cluster area or a single cluster area.

The link on the moving picture provides the user, who received search results, means for accessing moving pictures included in the moving picture cluster, which is provided as the search results, by referring to the location information (URL) of the moving picture.

The link on the moving picture can use the tile of the moving picture as an anchor text. Moreover, a still image of the moving picture can be used as a display image of the link. These anchor text and display image can be provided by using, for example, an HTML tag.

In case the search results display the links on a plurality of moving pictures included in one moving picture cluster, it may be required that the order of the links be determined. For example, the order of arranging the links in the cluster unit display area can be based on the order of relative time of arranging the moving pictures that are related to the links.

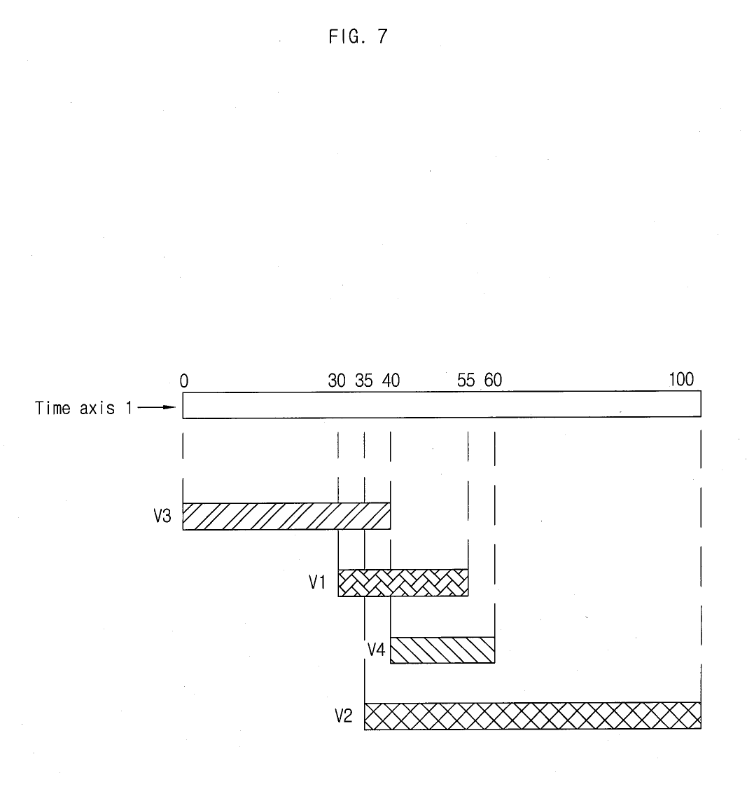

The relative arrangement of two moving pictures that share a common section (an overlapping section having the same video information) can be determined by comparing start points of the common section from the start point of each moving picture. This will be further described with reference to FIG. 7.

Take two moving pictures, for example, that have a common section of 10 seconds. Suppose a first moving picture V3, which is 40 seconds long, starts the common section 30 seconds after the start point, and a second moving picture V1, which is 25 seconds long, starts the common section at the start point. Then, the first moving picture V3 is considered 30 seconds ahead of the second moving picture V1, and thus the first moving picture V3 is arranged ahead of the second moving picture V1 in the order of arrangement.

Like the above example, the order of time arrangement of moving pictures belonging to a moving picture cluster can be determined by comparing moving pictures sharing the common section. In other words, the start points of all moving pictures included in the moving picture cluster can be arranged on one common time axis, the order of relative time arrangement of the moving pictures can be determined based on the order of their start points. The information on the arrangement of the moving pictures in the moving picture cluster can be stored as moving picture cluster data 17 in the database 15.

It shall be understood, however, that a mere arrangement of temporal order of moving pictures is not an object of the present invention and that the arrangement is not restricted to the method described above. It is also possible that any conventional method of arranging the temporal order of moving pictures can be used to realize the present invention.

Referring to FIG. 2 again, the link, which is provided in the cluster unit display area by the moving picture searching unit 13 as a part of the search results, can be displayed along with information of time section, in which the moving picture referred by the link occupies within the entire playback time section of the moving picture cluster. The entire playback time section of the moving picture cluster means a playback time section in case the entire moving pictures included in the moving picture cluster are relatively arranged based on each respective common section. In other words, the start point of a moving picture that appears first in the moving picture cluster becomes the start point of the playback time section of the moving picture cluster, and the end point of a moving picture that appears last in the moving picture cluster becomes the end point of the playback time section of the moving picture cluster. For example, if a certain moving picture starts 30 seconds after the start point of the playback time section of the moving picture cluster and lasts for 1 minute, the start time information of the section that the moving picture occupies becomes “30 seconds”, and the end time information becomes “1 minute 30 seconds.” Such information can indicate which section of the playback time section of the moving picture cluster the moving picture related to a link occupies.

The user can access an address at which the moving picture can be viewed, when the user clicks (selects) the provided link on the client terminal 20. Through such access, the user can view the moving picture related to the selected link. As described above, a still image of the moving picture can be used as a display image of the link, through which the user can be guided to view the moving picture.

It is also possible to provide additional information on the moving picture related to the link (i.e., which can be viewed at the address to which the link is connected) before the user clicks the provided link. For example, in case a pointer (e.g., a pointer controlled by a mouse) of a graphic user interface, which is realized on the client terminal, is placed on the link of the moving picture, the additional information on the moving picture related to the link can be displayed. The provided additional information can include the playback time, picture quality, description, tag, title of the webpage on which the moving picture can be viewed and uploader of the moving picture. Through such additional information, the user can be provided with basic information for deciding whether to click the link to view the moving picture.

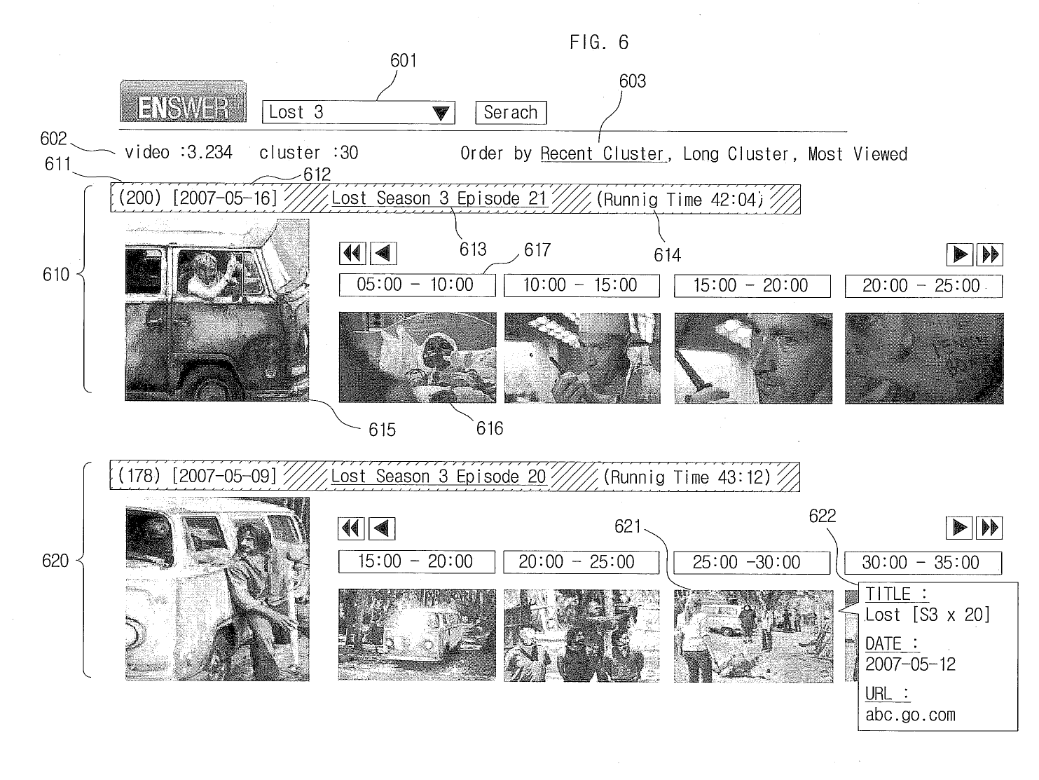

The additional information can be displayed as a visual effect, such as a separate layer, or as a separate pop-up window on a browser program window that displays the moving picture search results on the client terminal 20. FIG. 6 below will describe in detail on how the additional information can be provided.

In case a moving picture connected with a provided link, which is provided as a search result, shares a common section with another moving picture in the moving picture cluster, the link can be displayed in such a way that a link connected to a moving picture that does not share any common section with another moving picture is differentiated. By differentiating the link connected to a moving picture that is included in more webpages, the search results can be provided more efficiently.

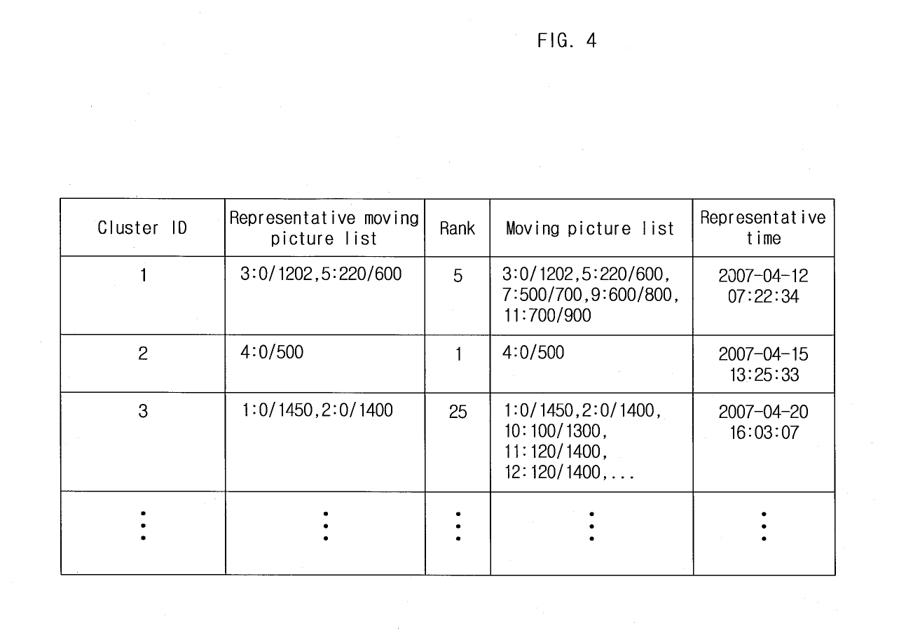

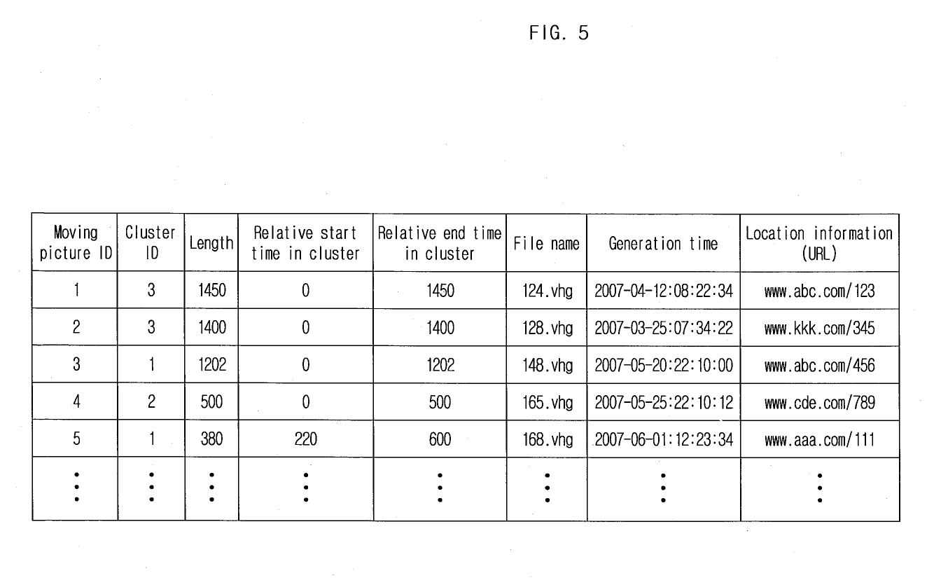

The database 15 can store the moving picture data 16 and the moving picture cluster data 17. The moving picture data 16 can be understood to include the moving picture itself as well as additional data (additional information) on the moving picture. The moving picture cluster data 17 includes a list of moving pictures that are included in a cluster identifier, which is assigned to the moving picture. The moving picture cluster data 17 can include, for example, the temporal order of arrangement of moving pictures in a moving picture cluster. Specific examples of the moving picture data 16 and moving picture cluster data 17 will be described later with reference to FIGS. 4 and 5.

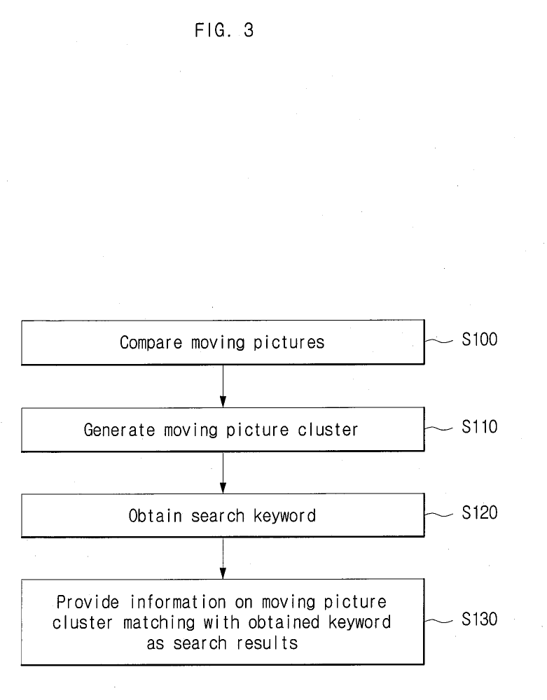

FIG. 3 is a flowchart for a method of providing a moving picture search service in accordance with an embodiment of the present invention.

In the step of comparing moving pictures, represented by reference numeral S100, the moving picture comparing unit 11 compares two on-line moving pictures to determine identity between the two moving pictures. Identity between two moving pictures means that the two moving pictures share substantially identical (which includes perfectly identical or similar) video information.

Two on-line moving pictures can be collected and stored in the database 15 prior to the comparing process. As described above with reference to FIG. 2, a variety of moving picture comparing technologies (e.g., a moving picture fingerprint extraction technology) can be used to find the identity between two moving pictures.

The information obtained during the collection of moving pictures to compare, for example, the title of the moving picture, the location of the moving picture and other text information included in the webpage at which the moving picture is located, can be stored in the database 15 as additional information of the moving picture.

In the step S110 of generating a moving picture cluster, the moving picture cluster generating unit 12 creates a moving picture cluster by assigning a same cluster identifier to two moving pictures determined to have identity. Moreover, in case moving pictures belonging to different moving picture clusters are found to have identity, the identifiers of the two moving picture clusters are changed so that the moving picture clusters are combined. The information on the generated moving picture cluster can be also stored in the database 15.

In the step S130 of obtaining a search keyword, the moving picture searching unit 13 of the apparatus for providing a moving picture search service 10 obtains the inputted keyword from the client terminal 20. The apparatus for providing a moving picture search service can be inputted with the search keyword through a user interface, which is available in conventional search engines, and the description thereof is well known to those of ordinary skill in the art and thus will be omitted here.

In the step S140 of providing information on a moving picture cluster matching with the search keyword as search results, the moving picture searching unit 13 sends the generated search results to the client terminal 20 by referencing the database 15.

The moving picture searching unit 13 can extract a moving picture cluster matching with the search keyword by comparing the information stored in the database 15 and the search keyword.

The search results provided by the moving picture searching unit 13 include a moving picture cluster list, in which moving picture clusters matching with the search keyword are grouped by each cluster unit.

In the search results, the information belonging to different moving picture clusters can be arranged on the client terminal 20 such that the user can recognize the difference of moving picture clusters. For example, a virtual closed line that includes information on one moving picture cluster may not cross another closed line that includes information on another moving picture cluster, on a screen that provides the search results. The arrangement of the moving picture cluster information can be realized by giving some space on the search result screen.

There can be a variety of criteria for determining which moving picture cluster is to be placed in the highest order in the moving picture cluster list. As described earlier with reference to FIG. 2, the criteria can be the number of moving pictures included in the moving picture cluster or the time information related to the moving picture included in the moving picture cluster. Alternatively, the length of the entire playback section of the moving picture cluster can be used as a criterion.

The order of arrangement the moving picture clusters can be pre-computed according to the criteria and stored in the database 15, or computed when the search results based on the search keyword are requested and reflect the computation on the search results.

The moving picture cluster information in the search results in accordance with an embodiment of the present invention can include a link that references the location information of a moving picture included in the moving picture cluster, and a link for a moving picture belonging to another moving picture cluster will be separately identified.

Suppose that the cluster identifiers 1, 2 and 5 are found to match with the search keyword, and the arrangement is determined to be in the order of clusters 2, 5 and 1. Then, the information on moving pictures belonging to the cluster identifier 2 will be placed higher than the information on moving pictures belonging to other moving picture clusters.

By providing the search results according to the moving picture clusters, the space taken up by redundant moving pictures (i.e., moving pictures sharing a common section) in the search results can be controlled.

The search results can be links for location information of webpages, in which moving pictures included in the moving picture cluster can be viewed. The link can use a still image at a point of the moving picture, which is connected to the link, as its display image.

As described above, the arrangement of links for a plurality of moving pictures belonging to the same moving picture cluster can be based on the order of relative time of the moving pictures related to the links.

When displaying the link referencing the location information of a moving picture, the display attribute of the link can be differently configured by reflecting how much the moving picture share the common section with another moving picture.

In case there is a section that is temporally overlapping based on the arrangement information between the links provided for the moving picture clusters, the links sharing a section that is temporally overlapping can be configured to have an effect, such as a different color or bold-face, in order to distinguish such links from other links. Through this, the user can recognize that more data, which are distinguished from other data, are present in the search results and that these data refer to an interesting part or highlight that more people seek. Hence, without having to view the entire moving picture, the user can conveniently view the corresponding section only.

As described earlier, the link provided in the cluster unit display area can be displayed together with information on a time section in which the moving picture referenced by the link occupies in the entire playback time section of the moving picture cluster. The information on a time section occupied by the moving picture can be a relative start time in the cluster and/or a relative end time in the cluster, as illustrated in FIG. 5.

Although the functions of searching a moving picture cluster matching with a keyword and arranging the order of search results were performed by the moving picture searching unit 13 in the description above, it shall be evident that the above functions can be performed by independent elements of the apparatus for providing a moving picture search service 10 in order to enhance the efficiency of the apparatus for providing a moving picture search service 10.

FIG. 4 illustrates the structure of moving picture clusters that are used for realizing a moving picture search service in accordance with an embodiment of the present invention. Referring to FIG. 4, the moving picture cluster data 17 stored in the database can include a cluster identifier, representative moving picture list, rank, moving picture list and time information.

The cluster identifier (cluster ID) is assigned by the moving picture comparing unit 11 and moving picture cluster generating unit 12 of FIG. 2, and the same cluster ID is assigned to moving pictures that have identity.

The representative moving picture list is a list of moving pictures that can represent moving pictures belonging to each cluster ID. The cluster ID 1 includes 2 units of data, each of which is expressed by 3:0/1202 and 5:220/600, respectively. The numbers “3” and “5” refer to moving picture identifiers. 3:0/1202 means that the moving picture, whose identifier is 3, occupies a section between 0 second and 1202 seconds in the playback time section of the moving picture cluster, and 5:220/600 means that the moving picture, whose identifier is 5, occupies a section between 220 seconds and 600 seconds.

There can be one or more representative moving pictures. Criteria for determining the representative moving picture can include the playback time (length) of a moving picture, picture quality, the number of other moving pictures that have identity in the same cluster, the length of the title, the location information of the moving picture, the number of hits for the moving picture (or the number of visitors to the website in which the moving picture is located) and the entropy computed for the title of the moving picture. Moreover, the qualifications for a representative moving picture can be considered. In order for a moving picture to be selected as a representative moving picture, the moving picture may be required to have certain picture quality and minimum length. It is also possible that two or more moving pictures are selected as the representative moving pictures based on different criteria.

The representative moving picture of a moving picture cluster can be selected based on the length of moving pictures in the moving picture cluster. The longest moving picture can be a strong candidate for the representative moving picture. For example, if there is a moving picture that includes all contents of the moving pictures included in the cluster, this moving picture can be selected as the representative moving picture. However, if the moving picture does not satisfy the minimum picture quality requirement despite the length, the moving picture may not be selected as the representative moving picture, and the longest moving picture among moving pictures that qualify the minimum picture quality requirement can be selected as the representative moving picture.

The representative moving picture can be selected based on how much a certain moving picture has identity with other moving pictures. A moving picture that has identity (i.e., shares a common section) with a relatively greater number of moving pictures can be a strong candidate for the representative moving picture. It can be expected that such moving picture is posted (or shared) by a large number of users and thus is a highlight of the moving picture cluster. In this case, it would be efficient to apply a minimum length requirement such that too short a moving picture is prevented from being selected as the representative moving picture.

Alternatively, by selecting a moving picture that has the greatest number of other moving pictures having identity in the same moving picture cluster as the representative moving picture, the user can be provided with efficient means for accessing the highlight of the moving picture that is most shared in the cyberspace.

By referring to location information of moving pictures, a copyrighted moving picture, which is available through an authorized distribution route, can be selected as the representative moving picture. Selection of such moving picture can positively affect the protection of copyright in the cyberspace.

The cluster unit display area in accordance with an embodiment of the present invention can display the information on the representative moving picture in the form of a link. The display attributes of a link for another moving picture and the display attribute for a link for the representative moving picture in a moving picture cluster can be differentiated. For example, the link for the representative moving picture (i.e., the link referencing the location information of the representative moving picture) can have a bigger display image than the links for other moving pictures do in the same cluster unit display area. Alternatively, the area in which the link for the representative moving picture is displayed can be visually differentiated from areas in which the links for other moving pictures are displayed.

Rank refers to the number of moving pictures included in the moving picture cluster. As described earlier, the number of moving pictures included in a moving picture cluster can be used as an arrangement criterion in the moving picture search results in accordance with an embodiment of the present invention.

Referring to the moving picture list for the cluster identifier 1, 5 pieces of data (3:0/1202, 5:220/600, 7:500/700, 9:600/800, 11:700/900) are displayed for 5 moving pictures. Each of the data has the same types (the moving picture identifier and the start point and end point of the section the moving picture occupies in the playback section of the moving picture cluster) as the representative moving picture.

Representative time refers to the time information that can be used for arrangement of the moving picture cluster. The representative time of a moving picture cluster can be determined based on the time information that a moving picture belonging to the moving picture cluster is generated. The generation time of a moving picture that has either the earliest or the latest time of generation among the moving pictures included in the moving picture cluster can be regarded as the representative time of the moving picture cluster. In some case, the mean value of the generation times of the moving pictures belonging to the moving picture cluster can be regarded as the representative time of the moving picture cluster.

FIG. 5 illustrates the structure of a moving picture list used to realize a moving picture search service in accordance with an embodiment of the present invention. Referring to FIG. 5, the moving picture data 16 can include a moving picture ID, cluster ID, length, relative start time in the cluster, relative end time in the cluster, file name, generation time and location (address) information.

The moving picture ID refers to identification information assigned to identify each of the moving pictures stored in the database 15. The cluster ID refers to an identifier of a cluster in which the moving picture is included. The length refers to the length of a time section during which the moving picture is played back.

The relative start time in the cluster indicates how long after the start point of the moving picture cluster (i.e., the start point of a moving picture that has the earliest temporal order of arrangement in the moving picture cluster) a moving picture starts, in case the temporal order of moving pictures is determined in the moving picture cluster, in which the moving picture is included. Therefore, the relative end time in the cluster can be computed by adding the length of the moving picture to the relative start time in the cluster.

As described earlier, the moving pictures in the same moving picture cluster can be arranged on the same time axis by using the time information of the common section shared by the moving pictures, and the relative start time and relative end time in the cluster are expressed by use of this time axis. The arrangement of the moving pictures in the moving picture cluster will be described later in further detail with reference to FIG. 7.

The generation time refers to the time at which the moving picture is generated. The generation time can be when the moving picture was actually photographed or posted in the on-line space. The time at which the moving picture was photographed can be obtained by use of Meta information included in the moving picture. The posting time of the moving picture can be obtained through, for example, web robot, from which the moving picture was collected.

The location information refers to the address information at which the moving picture can be viewed in the cyberspace. For example, the moving picture can be an object inserted (e.g., by use of an <embed> tag) to a certain web document. In addition, the URL information of a web document, at which the moving picture can be viewed, can be the location information of the moving picture. Moreover, in case the URL information of a web document in which the moving picture itself is stored can be obtained, the URL information can be stored as the location information of the moving picture.

As described earlier, the moving picture search results are provided with moving picture clusters within one moving picture cluster list, and the information on each moving picture cluster can include links that reference the location information of moving pictures included in the moving picture cluster. If multiple links are provided for a single moving picture cluster, the links can be arranged based on the relative start time and/or relative end time in the cluster of the moving pictures. The links arranged as such can display the still images related to the links as their display images.

FIG. 6 illustrates moving picture search results displayed in a client terminal in accordance with an embodiment of the present invention.

A keyword inputted by the user here is “Lost 3” 601, which is the title of a drama series well known throughout the world. The inputted search keyword is sent to the apparatus for a moving picture search service 10, and the moving picture searching unit 13 provides information on a moving picture cluster, cluster by cluster, matching with “Lost 3.”

There are 3,234 moving pictures searched for the search keyword of “Lost 3,” and these moving pictures can be grouped in 30 moving picture clusters, as shown in reference numeral 602. Therefore, the search results can include 30 cluster unit display areas. In FIG. 6, cluster unit display areas 610 and 620 for 2 moving picture cluster are illustrated, for the convenience of description. The number of cluster unit display areas that can be provided on one screen of a client terminal can depend on the user configuration (e.g., the size of provided image and/or font) of the moving picture search service and the hardware specifications (e.g., the resolution of the display device) of a client terminal, to which the search results are provided.

Shown on the upper most part 602 of the search results are the total number of searched moving pictures and the number of clusters. In the case of FIG. 6, there are 3,234 moving pictures matching with the search keyword of “Lost 3” and 30 related moving picture clusters.

If links for individual moving pictures were listed, without using the moving picture cluster, the links for 3,234 moving pictures would have to be provided, regardless of identity between the moving pictures. This would be excessively long for the user to look through. By providing the 3,234 moving pictures in groups of 30 cluster unit display areas, the length of the list that the user is to look through will be substantially reduced. For example, a first cluster unit display area 610 provides information on 200 moving pictures, by using a part of the screen of the client terminal 20.

In the illustrated search results screen, the cluster unit display areas 610 and 620 are arranged based on the representative time of their corresponding moving picture clusters, and the most recently generated moving picture cluster is listed first, as shown in reference numeral 603. In addition, there can be a variety of criteria for which the cluster unit display areas are arranged. For example, user statistics for moving pictures can be used to as a criterion. If moving pictures belonging to a certain moving picture cluster have a large number or frequency of viewing, the cluster unit display area corresponding to the moving picture cluster can be placed at a relatively higher position.

Moreover, the length of the entire playback time section for each moving picture cluster (i.e., the entire video length of a moving picture cluster) can be used to arrange the cluster unit display areas. It is likely that users searching for a drama or a movie are interested in a moving picture cluster that has a relatively longer playback time section. By contrast, users searching for a movie preview or a commercial film would be interested in a moving picture cluster that has a relatively shorter playback time section. Therefore, it can be efficient to use the length of playback time as a criterion for arranging the search results. For example, it would be possible to provide arrangement options of shorter than 10 minutes, longer than 30 minutes and longer than 1 hour.

A first moving picture cluster corresponding to the first cluster unit display area 610 includes 200 moving pictures, as shown in reference numeral 611. The representative time of the first cluster unit display area 610 is indicated as May 16, 2007, as shown in reference numeral 612. In an embodiment of the present invention, the representative time of a moving picture cluster can be the earliest generation time of moving pictures included in the moving picture cluster. In FIG. 6, May 16, 2007 can refer to the date of the earliest generation (upload) among the moving pictures included in the first moving picture cluster corresponding to the first cluster unit display area 610. (On May 16, 2007, Episode 21 of Season 3 of “Lost” was aired.) The title of the first moving picture cluster is indicated as “Lost Season 3 Episode 21” in reference numeral 613, and the length of the playback time section of the first moving picture cluster is 42 minutes 4 seconds, as shown in reference numeral 614. That is, the longest moving picture included in the first moving picture cluster will be 42 minutes 4 seconds long.

The first cluster unit display area 610 can include links 615 and 616 for moving pictures belonging to its corresponding first moving picture cluster. The link for each moving picture can use a still image of a moving picture, which is related to the link, as its display image. The first cluster unit display area 610 has 5 links, expressed by use of such still images. The link 610 for the representative moving picture of the first moving picture cluster can be provided in attributes that are differentiated from other links. In the first cluster unit display area 610, a link for the representative moving picture is displayed bigger than the other 4 links for other moving pictures. It is not necessary that the first moving picture cluster has one moving picture only, and two or more moving pictures, based on different criteria, can be selected as representative moving pictures. In such a case, the first cluster unit display area 610 can include links for two or more representative moving pictures.

Next to the link 615 for the representative moving picture, 4 links arranged according to the temporal order in the first moving picture cluster are displayed. Above each of the 4 links, the time section in the moving picture cluster that is occupied by the moving picture related to the link (i.e., the moving picture of which the location information is referenced by the link) in the moving picture cluster is displayed. That is, the moving picture related to the first link 616 of the 4 links corresponds to a playback time section between 5 minutes and 10 minutes with reference to the entire playback time section, as shown in reference numeral 617. It is also possible that the relative start time and end time in the cluster are displayed.

In case a link 621 provided in a second cluster unit display area 620 is clicked, the user can view a moving picture corresponding to the location information referenced by the link. However, preview information for the link can be provided prior to viewing the link, allowing for added convenience to the user. If the user places a pointer, such as the mouse, on the link 621, additional information for a moving picture related to the link can be provided. Providing the information on a moving picture and a webpage, which can be browsed when the link is clicked, will be helpful to the user. In FIG. 6, the title, date of generation and domain information of a moving picture, which the user can view when the link 621 is clicked, are provided in a separate pop-up window, as shown in reference numeral 621. Moreover, other information (e.g., user comments and tag) that can be collected in the webpage, in which the moving picture is located, can be provided through such a pop-up window.

FIG. 7 illustrates how moving pictures in a moving picture cluster are arranged on a common time axis in accordance with an embodiment of the present invention. Referring to FIG. 7, the moving picture cluster consists of 4 moving pictures, each of which is named V1, V2, V3 and V4, respectively.

The entire playback time section of the moving picture cluster is 100 seconds long, and occupies a time axis 1 between 0 second and 100 seconds.

Moving picture V3 occupies 0 second to 40 seconds in the entire playback time section of this moving picture cluster. The relative start time of moving picture V3 in the cluster is 0 second, and its relative end time is 40 seconds.

In FIG. 7, V1 and V2 are most prospective candidates for the representative moving picture. V1 shares the common section with the most number of moving pictures in the moving picture cluster. Thus, V1 can be the representative moving picture that corresponds to the highlight of the entire playback time section in the moving picture cluster.

As the longest moving picture, V2 can be selected as the representative moving picture. However, if there were another moving picture with the same playback time (length) as the entire playback time section (100 seconds) of the moving picture cluster, the full-length moving picture would be the representative moving picture.

If 4 links corresponding to the moving pictures in FIG. 7 are provided as search results, the arrangement of the 4 moving picture links can be based on the temporal order in the moving picture cluster. For example, if the temporal order is based on the relative start time of the moving pictures in the moving picture cluster, the search results will be arranged in the order of V3, V1, V2 and V4.

The temporal order can be based on the relative start time and the relative end time of the moving pictures in the cluster. Mean values of these two times for V3, V1, V4 and V2 are 20, 42.5, 50 and 67.5, respectively. Therefore, the order of arrangement based on this criterion will be V3, V1, V4 and V2.

The link displayed in the search results can use a still image of a moving picture referenced by the link as its display image. In case a plurality of links are provided as the search results, the plurality of links can be arranged based on the order by which still images corresponding to the display images are arranged in the entire playback time section of the moving picture cluster.

For example, if the link of V1 uses a still image located at 50 seconds of the entire playback time section on the time axis 1, and the links for V4 and V2 use a still image at 40 seconds and 70 seconds, respectively, the order of arrangement for the three links will be V4, V1 and V2. As such, the links provided in the search results can be arranged based on the relative temporal order of their display images.

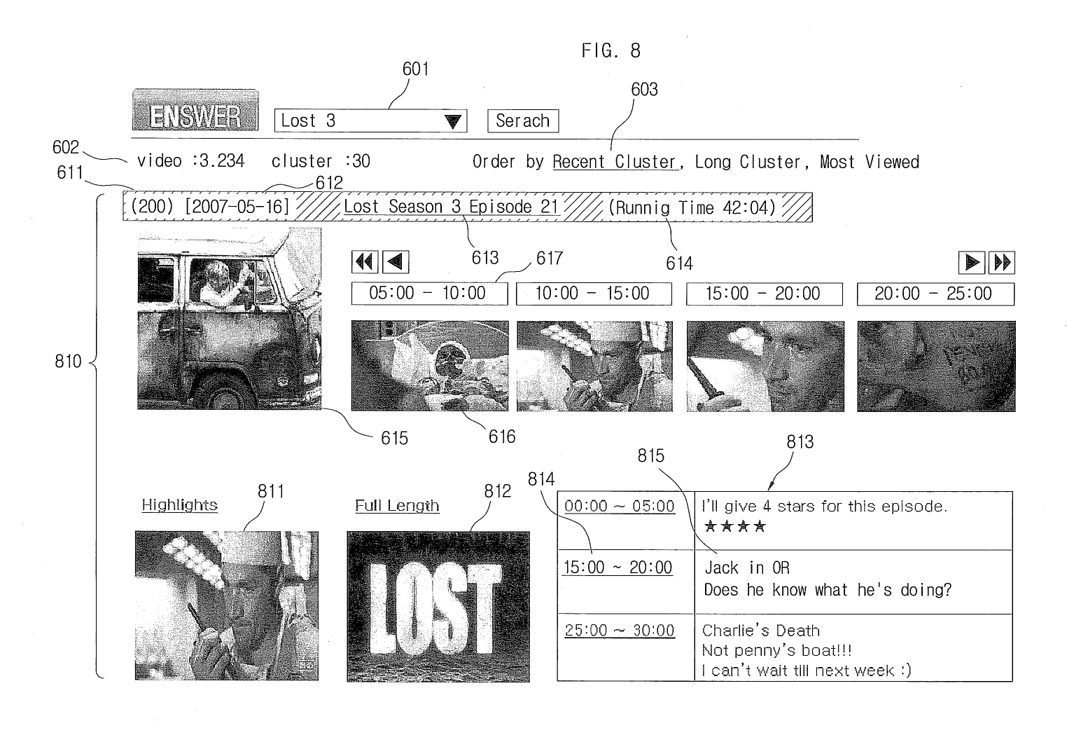

FIG. 8 illustrates moving picture search results displayed in a client terminal in accordance with an embodiment of the present invention. For the convenience of description, FIG. 8 illustrates one cluster unit display area.

A cluster unit display area 810 shown in FIG. 8 can be understood as an expansion of the first cluster unit display area 610 shown in FIG. 6. The cluster unit display area 810 displays the same moving picture cluster information as the first cluster unit display area 610. The upper part of the cluster unit display area 810 is identical to that of the first cluster unit display area 610, and thus the description will be omitted.

Referring to FIG. 8, a link 811 for a highlight moving picture and a link 812 for an entire length moving picture are provided as links for the representative moving picture. As described earlier, the highlight moving picture can be selected based on the number of other moving pictures having identity with a certain moving picture within the same cluster.

Referring to FIG. 8, the cluster unit display area 810 displays additional information collected from webpages in which the moving pictures belonging to the moving picture cluster are located, as shown in reference numeral 813. In FIG. 8, this area takes the time section in which a moving picture occupies in the moving picture cluster as the anchor text, and a link 814 referencing the moving picture and a user comment 815 collected from the webpage in which the moving picture is located are displayed. In addition, it would be possible to display the description, tag and copyright information of the moving picture as the additional information of the moving picture cluster.

The method of providing a moving picture service in accordance with an embodiment of the present invention can be realized as digital codes on a computer-readable recording medium, which includes any kind of recording medium in which data that can be read by a computer system is stored. This includes, for example, a ROM, RAM, CD-ROM, magnetic tape, floppy disk and optical data storage device, as well as a type of carrier wave (e.g., transmission through the Internet).

Terms used in this application are used to describe certain embodiments only and shall not be used to restrict the present invention. Any expression in a singular number includes the meaning of a plural number, unless otherwise expressed explicitly in the context.

Terms such as “include” or “have” in the present application are intended to indicate the presence of a feature, number, step, operation, element, part and combinations thereof disclosed in the description, and shall not be understood to preclude one or more other features, numbers, steps, operations, elements, parts or combinations thereof.

Terms such as “first” and “second” can be used to describe a variety of elements, but such elements shall not be restricted by these terms, which are used to distinguish one element from another element only.

Hitherto, some embodiments of the present invention have been described. However, there can be many other embodiments within the claims of the present invention. Anyone of ordinary skill in the art to which the present invention pertains shall understand that the present invention can be realized in forms of permutations, without departing from the fundamental features of the present invention. Therefore, the disclosed embodiments shall be understood in a perspective of description, not restriction. The scope of the present invention is disclosed in the appended claims, not in the above description, and any and all differences in the equivalent scope shall be understood to be included in the present invention.

### INDUSTRIAL APPLICABILITY

According to an embodiment of the present invention, a method of providing a moving picture search service and an apparatus therefor can be provided by using a moving picture cluster including moving pictures having identity.

1. A method of providing a moving picture search service, comprising:
obtaining a search keyword from a client terminal; and
providing as search results a moving picture cluster list displaying information about a moving picture cluster matching with the search keyword,
wherein the moving picture cluster comprises a plurality of moving pictures determined to have identity, and
the moving picture cluster list comprises a cluster unit display area displaying information about the moving picture cluster differently from information about another moving picture cluster included in the moving picture cluster list.

2. The method of claim 1, wherein the moving picture cluster list comprises a plurality of cluster unit display areas, and
the plurality of cluster unit display areas are arranged based on the number of moving pictures included in each moving picture cluster corresponding to each of the cluster unit display areas.

3. The method of claim 1, wherein the moving picture cluster list comprises a plurality of cluster unit display areas, and
the plurality of cluster unit display areas are arranged based on cluster representative times for their corresponding moving picture clusters, and
the cluster representative times are generated based on a generation time of a moving picture included in each cluster.

4. The method of claim 3, wherein the cluster representative time is an earliest time among generation times of moving pictures included in each moving picture cluster.

5. The method of claim 1, wherein the cluster unit display area displays a link referencing location information of a moving picture belonging to a moving picture cluster corresponding to the cluster unit display area.

6. The method of claim 5, wherein the cluster unit display area displays links for a plurality of moving pictures belonging to the moving picture cluster, and
the links display corresponding moving pictures based on a temporal arrangement order in the moving pictures cluster.

7. The method of claim 6, wherein the temporal arrangement order considers at least one of a relative start time and a relative end time in a cluster that each of the plurality of moving pictures has.

8. The method of claim 5, wherein the link uses a still image of the moving picture as a display image of the link.

9. The method of claim 8, wherein the cluster unit display area displays links for a plurality of moving pictures belonging to the moving picture cluster, and
the plurality of links are arranged based on an order of arrangement of still images corresponding to display images of the links in an entire playback time section of the moving picture cluster.

10. The method of claim 5, further comprising providing additional information for the moving picture related to the link, in case a pointer of a graphic user interface (GUI) realized on the client terminal provided with the moving picture cluster list is placed on the link.

11. The method of claim 6, wherein the cluster unit display area displays at least one of start time information and end time information of a section occupied in an entire playback time section of the moving picture cluster corresponding to the cluster unit display area.

12. The method of claim 1, wherein the cluster unit display area displays information about a representative moving picture selected among moving pictures belonging to the moving picture cluster matching with the search keyword.

13. The method of claim 12, wherein the information about the representative moving picture displayed in the cluster unit display area comprises at least one of links referencing a still image of the representative moving picture and the representative moving picture.

14. The method of claim 12, wherein the representative moving picture is selected based on a length of a moving picture belonging to the moving picture cluster matching with the search keyword.

15. The method of claim 12, wherein the representative moving picture is selected based on the number of other moving pictures having identity with a moving picture belonging to the moving picture cluster matching with the search keyword.

16. A computer-readable recording medium, having recorded a program for executing a method of any one of claims 1 to 15 in a computer.

17. An apparatus for a moving picture search service, comprising:
a database, storing information on a moving picture cluster including a plurality of moving pictures determined to have identity; and
a moving picture searching unit, providing a moving picture cluster list displaying information about a moving picture cluster matching with a search keyword as search results, by searching the database, in response to the search keyword obtained from a client terminal,
wherein the moving picture cluster list comprises a cluster unit display area displaying information about the moving picture cluster for each cluster.

18. The apparatus of claim 17, further comprising:
a moving picture comparing unit, detecting identity between two moving pictures by comparing the two moving pictures; and
a cluster generating unit, forming a moving picture cluster by assigning a same cluster identifier to two moving pictures in which identity is detected by the moving picture comparing unit.
